(19) United States
(12) Patent Application Publication
(10) Pub. No.: US 2010/0186786 A1
(43) Pub. Date: Jul. 29, 2010

(54) Warewasher having a Rack Sensor

(75) Inventor: James J. Bittner, Philadelphia, PA (US)

Correspondence Address: HOWSON & HOWSON LLP, 501 OFFICE CENTER DRIVE, SUITE 210, FORT WASHINGTON, PA, 19034, US

(73) Assignee: INSINGER MACHINE COMPANY, Philadelphia, PA (US)

(21) Appl. No.: 12/690,182

(22) Filed: Jan. 20, 2010

Related U.S. Application Data
(60) Provisional application No. 61/148,212, filed on Jan. 29, 2009.

(51) Int. Cl. B08B 3/00; H01H 9/00

(52) U.S. Cl. 134/56 D; 335/205

(57) ABSTRACT

A sensor assembly is provided for determining the presence or lack thereof of a removable dishware rack within a chamber of a warewasher. The sensor assembly includes a mounting bracket within the chamber of the warewasher at a location beyond a path of travel of the dishware rack and a pivot arm connected to the mounting bracket. The pivot arm is moveable relative to the mounting bracket between a normal upright position and an angularly deflected position in which the pivot arm is pivoted in an outward direction relative to the path of travel of the rack. A magnet is mounted on the pivot arm and an actuator extends forwardly from the pivot arm within the path of travel of the dishware rack within the chamber when the pivot arm is in the normal upright position. The pivot arm pivots to the deflected position when the dishware rack is properly loaded within the chamber and engages the actuator. A magnetic proximity switch is mounted on the warewasher for sensing the magnet. Accordingly, the magnetic proximity switch is able to determine if the pivot arm is in the normal position or the deflected position thereby enabling the sensor assembly to determine whether or not a removable rack is loaded within the warewasher. A door-type, stationary-rack warewasher having the sensor assembly is also disclosed.

### CROSS-REFERENCE TO RELATED APPLICATIONS

This application claims the benefit under 35 USC §119(e) of U.S. Provisional Patent Application No. 61/148,212, filed Jan. 29, 2009.

### BACKGROUND OF THE INVENTION

The present invention relates generally to apparatus for washing dishes, pots, and like articles, and more particularly, the present invention relates to a door-type warewasher that includes a sensor for automatically sensing whether or not a warewashing rack is present within the warewasher before initiating a cleaning cycle.

So called “door type” warewashers are commonly utilized by institutional organizations, such as prisons, schools, and the like, which are required to clean a large quantity of dishware, pots, pans, trays and/or like articles on a daily basis. Typically, a warewasher has a substantially rectangular wash/rinse chamber accessed by a door which, when closed, forms at least a part of one of the walls of the wash/rinse chamber. The chamber is adapted to receive one or more racks loaded with dishware and the like which are to be washed and rinsed within the chamber after the door is closed. Examples of commercially available door-type warewashers include Insinger Commander 18-5 Automatic Single Tank Door Type Dishwasher and Insinger Door Type, Single Tank Scullery Machine manufactured by Insinger Machine Company of Philadelphia, Pa.

A typical cleaning cycle includes a wash period, a hot rinse period, and a short dwell period between the wash and rinse periods or at the end of the cycle. Merely for purposes of example, a complete cycle may run for about 60 seconds, 90 seconds, or other predetermined period of time. Door-type warewashers are also typically referred to as “stationary rack” warewashers since the rack remains substantially stationary within the chamber during the entire washing and rinsing process until the door of the warewasher is opened and the rack is removed.

Conventional stationary rack warewashers have utilized one of two different start mechanisms for activating the cleaning cycle of the warewasher. Some warewashers include a manually-operated push button which is located on the exterior of the chamber and which is manually depressed by the user to initiate the cleaning cycle after the door is closed. More recently, door-type warewashers have been provided with an automatically-operated, door-mounted switch which automatically initiates the cleaning cycle when the door closes.

When many racks of dishware or the like are required to be washed in a short period of time, warewashers having automatic door initiation are preferred. This is due to the elimination of the step of having to locate and press a manually-operated start button to initiate every cleaning cycle. However, automatic initiation is not preferred when racks of dishware or the like are washed only occasionally, for instance, in intervals of every three minutes or other extended period of time. This is because a machine-empty cycle occurs when the dishwasher door is closed after a full rack of cleaned dishware is removed and before another rack is loaded into the wash chamber. Of course, such a machine-empty cycle wastes energy and unnecessarily increases utility costs. Alternatively, if the door is left open for a delayed amount of time to prevent a machine-empty cycle from occurring, heat escapes from the warewasher also causing a waste of energy. Thus, in these situations, manually-operated push button activation is preferred since the door can be shut without automatically initiating a machine-empty cycle.

Although the aforementioned door-type, stationary-rack warewashers function satisfactorily for their intended purposes, there is a need for a door-type, stationary-rack dishwasher which enables increased rates of cleaning and an efficient use of energy. To this end, the warewasher should enable automatic activation, should prevent the occurrence of machine-empty cycles, and should prevent the loss of heat from the washing/rinsing chamber between machine-full cleaning cycles.

### SUMMARY OF THE INVENTION

According to a first aspect of the present invention, a sensor assembly is provided for determining the presence or lack thereof of a removable dishware rack within a chamber of a warewasher. The sensor assembly includes a mounting bracket mounted in a stationary position within the chamber of the warewasher at a location beyond a path of travel of the dishware rack within the chamber, and a pivot arm connected to the mounting bracket and moveable relative to the mounting bracket between a normal upright position and an angularly deflected position in which the pivot arm is pivoted in an outward direction relative to the path of travel of the rack. A magnet is mounted on the pivot arm and an actuator extends forwardly from the pivot arm within the path of travel of the dishware rack within the chamber when the pivot arm is in the normal upright position. The pivot arm pivots to the deflected position when the dishware rack is properly loaded within the chamber and engages the actuator causing the pivot arm to pivot to the deflected position in which the actuator is pushed outside of the path of travel of the rack. A magnetic proximity switch is mounted on the warewasher for sensing the magnet. Accordingly, the magnetic proximity switch is able to determine if the pivot arm is in the normal position or the deflected position thereby enabling the sensor assembly to determine whether or not a removable rack is loaded within the warewasher.

According to another aspect of the present invention, a warewasher is provided. The warewasher includes a plurality of walls defining an enclosed wash chamber within the warewasher. One or more of these walls comprises a door capable of being opened for loading and/or unloading a removable dishware rack. At least one track extends within the chamber for supporting the removable dishware rack in a stationary position within the chamber during a wash cycle. The track also defines a path of travel of the removable dishware rack by which the dishware rack is loaded into the chamber and/or is unloaded from the chamber. The warewasher also includes a rack sensor assembly including a mounting bracket mounted in a stationary position on an external side of the track within the chamber, a pivot arm connected to the mounting bracket and moveable relative to the mounting bracket between a normal position and a deflected position in which the pivot arm is pivoted in an outward direction relative to the track, a magnet mounted on the pivot arm, and an actuator extending from the pivot arm over the track and within the path of travel of the dishware rack within the chamber when the pivot arm is in the normal position. The pivot arm pivots to the deflected position when the dishware rack is properly loaded within the chamber and the rack engages the actuator causing the pivot arm to pivot to the deflected position in which the actuator is pushed to a location outside the path of travel of the rack. The warewasher also includes a magnetic proximity switch mounted externally on the warewasher for sensing the magnet so that the magnetic proximity switch is able to determine if the pivot arm is in the normal position or the deflected position thereby enabling the sensor assembly to determine whether or not the removable rack is loaded within the warewasher.

The magnetic proximity switch can have a corresponding electrical contact that opens when the pivot arm is in the normal position and that closes when the pivot aim is in the deflected position, and the door of the warewasher can have a corresponding electrical contact that opens when the door is opened and that closes when the door is closed. With this arrangement, a wash cycle of the warewasher can be prevented from being initiated until the electrical contacts of both the magnetic proximity switch and the door are closed.

### BRIEF DESCRIPTION OF THE DRAWINGS

The features of the present invention should become apparent from the following description when taken in conjunction with the accompanying drawings, in which:

FIG. 1 is a perspective view of a door-type warewasher having a rack sensor according to the present invention;

FIG. 2 is a perspective view of a rack sensor according to the present invention which can be mounted within a warewasher to automatically sense whether or not a rack is present within the wash/rinse chamber;

FIG. 3 is a top plan view of the rack sensor of FIG. 2 when a rack is not present within the warewasher;

FIG. 4 is a top plan view of the rack sensor of FIG. 2 when a rack is present within the warewasher;

FIG. 5 is a side elevational view of the rack sensor of FIG. 2 when a rack is not present within the warewasher;

FIG. 6 is a side elevational view of the rack sensor of FIG. 2 when a rack is present within the warewasher; and

FIG. 7 is a simplified electrical circuit diagram of the cleaning cycle initiation circuit of a stationary-rack warewasher embodying the present invention.

### DETAILED DESCRIPTION OF THE INVENTION

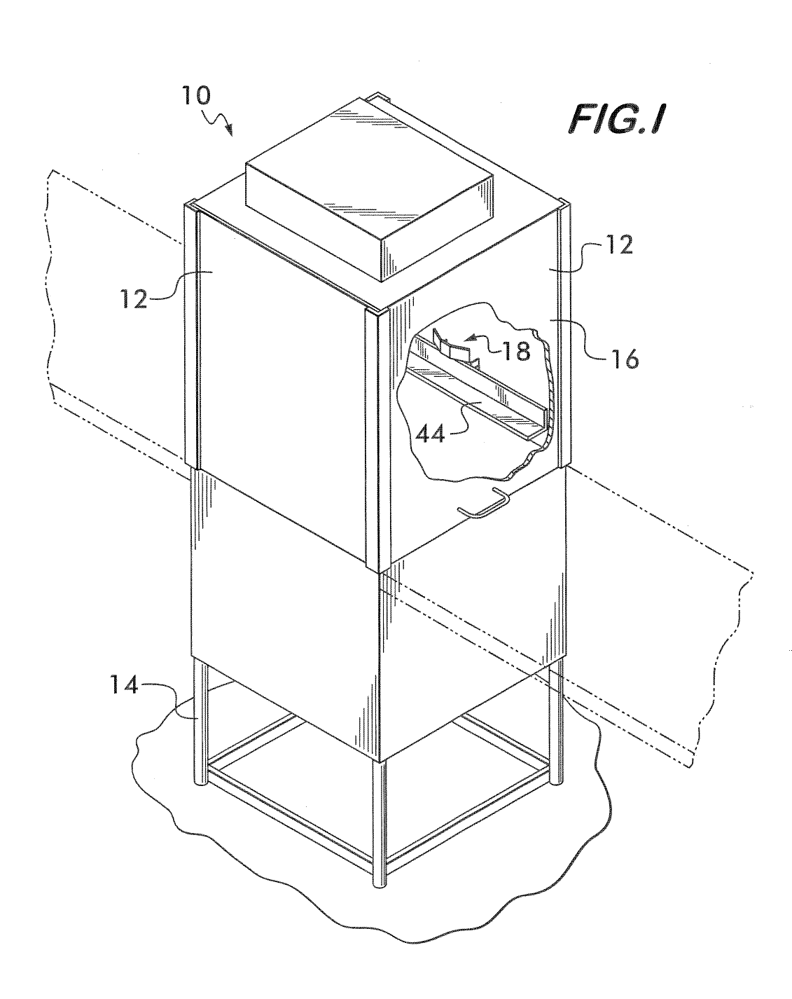

An example of a door-type, stationary-rack warewasher 10 is illustrated in FIG. 1. Such a warewasher 10 typically has walls 12 made of stainless steel supported on a frame 14 also preferably made of stainless steel. The walls 12 define a wash chamber into which a separate, removable rack (not shown) containing and supporting dishware and/or like articles can be loaded. Such a rack is typically made of plastic, is rectangular or square in plan, has an open top, upstanding sidewalls, and an openwork bottom panel permitting fluid to flow therethrough.

One or more of the walls 12, or a section of one or more of the walls 12, of the warewasher 10 has at least one manually-operated door 16 which can be manually positioned in an open position to load, or unload, racks and in a closed position to seal the wash/rinse chamber so that a cleaning cycle can be initiated. By way of example, the warewasher 10 can have a single door 16 or multiple (i.e., two, three, or more) doors which cooperatively open to permit access to the wash chamber. For example, if a single door is utilized, racks are loaded and unloaded through the same opening. Alternatively, doors can be formed in opposite walls to permit racks to pass through the warewasher, for instance, see FIG. 1. As another alternative, the doors can be provided on adjacent walls so that the warewasher can be position in the corner of a room enabling a rack to be loaded into the warewasher in a direction that is disposed 90° from a direction in which the rack is unloaded from the warewasher.

A set of spray and/or nozzles (not shown) are located in the wash chamber for directing a heated fluid at the dishware or like articles supported on the rack during a cleaning cycle. For example, a spinning wash and/or spray arm can be disposed to direct fluid onto a rack from above the rack and a spinning wash and/or spray arm can be disposed to direct fluid up into the rack from below the rack.

The cleaning cycle can include both a wash cycle for directing hot soapy water at the dishware or like articles and a hot rinse cycle for directing hot rinse water at the dishware or like articles. A dwell period can occur between the wash and rinse cycles and/or at the end of the cleaning cycle. Merely for purposes of example, an entire cleaning cycle may take only about 60 seconds providing the warewasher with a capacity of cleaning sixty racks per hour so that approximately 1500 dishes can be cleaned per hour. Of course, any other period of time can also be used; for instance, the cleaning cycle can take about 90 seconds or more. For purposes of preventing heat from escaping the wash/rinse chamber, it is preferably that the door 16 remains in a closed position at the end of each cleaning cycle.

According to the present invention, the cleaning cycle is automatically initiated when both the door 16 is closed and the presence of a properly positioned rack is sensed within the wash/rinse chamber of the warewasher 10. If the door 16 is open or if the presence of a rack is not sensed, a new cleaning cycle will not begin. This prevents the occurrence of machine-empty cycles when the door is opened to remove a rack and then closed and permits the door to remain closed before a next desired cleaning cycle to prevent heat from escaping the chamber.

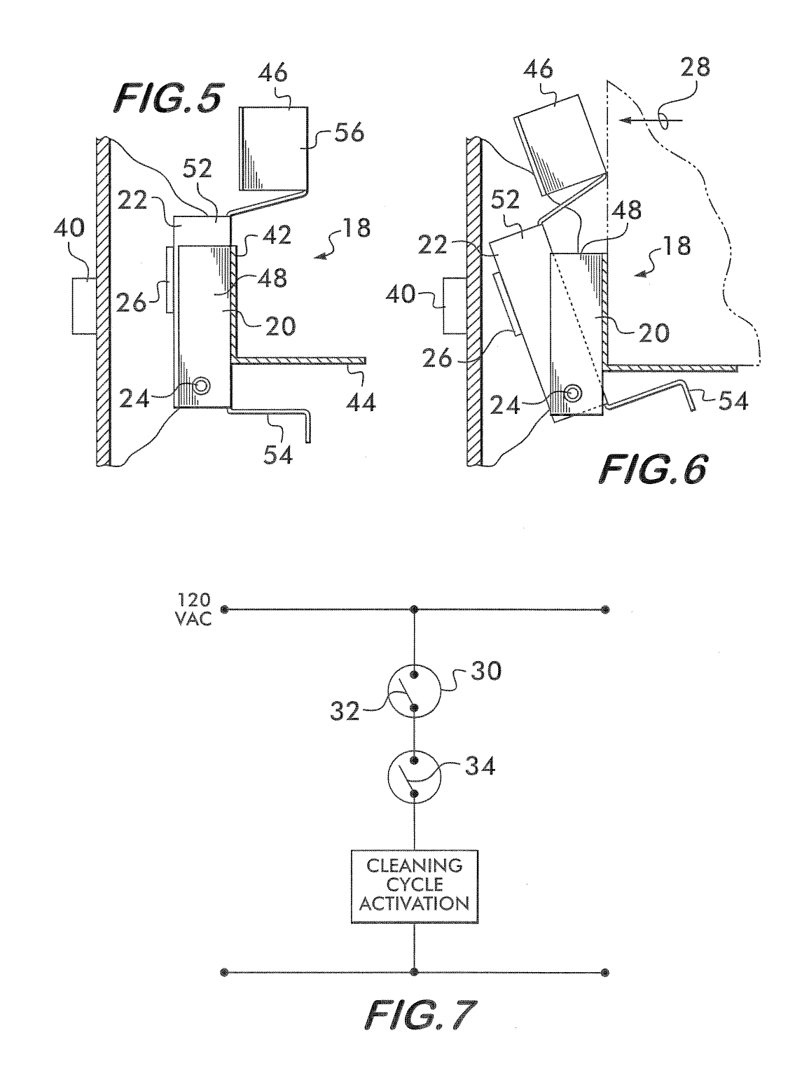

A rack is sensed within the warewasher 10 by a sensor assembly 18 illustrated in FIGS. 1-6 and a corresponding magnetic proximity switch 40. The sensor assembly 18 is mechanically fixed within the warewasher 10 at a location where a rack can contact the assembly 18 and toggle the assembly 18 between a first position indicating the absence of a rack within the chamber (see FIGS. 3 and 5) and a second position indicating the presence of a rack within the chamber (see FIGS. 4 and 6). As an example, the sensor assembly 18 can be mounted on the outside upright 42 of an L-shaped track 44 that supports a rack during a washing or rinsing cycle within the warewasher 10. Of course, the sensor assembly 18 can be mounted at other locations within the warewasher 10 that enable a rack to engage a part of the assembly 18.

In the illustrated embodiment, the sensor assembly 18 includes an anchor plate or mounting bracket 20, a pivot plate or arm 22, a hinge or pivot pin 24, and a magnet 26. FIGS. 1, 3 and 5 illustrate a normal upright position or first position of the sensor assembly 18 when a rack is not present and/or does not properly engage the assembly 18. The assembly 18 is properly weighted to return to this position automatically when acted upon only by the force of gravity. As best illustrated in FIG. 5, an actuator 46 of the pivot arm 22 extends over the track 44 and on a rack-side of the upright 42. In this position, the actuator 42 extends within the path of travel of a rack when a rack is properly inserted and loaded within the warewasher 10. Only when there is no rack in a loaded position within the warewasher can the actuator extend to the normal position shown in FIGS. 3 and 5.

The magnetic proximity switch 40 is mounted in a stationary position such as on the exterior of the warewasher 10 at a location in-line with the magnet 26 carried by the pivot arm 22 of the sensor assembly 18. When the sensor assembly 18 is in the normal position as shown in FIGS. 3 and 5, the magnetic proximity switch 40 does not sense the magnet 26 due to the amount of spacing therebetween, and therefore, the electrical contact 34 (see FIG. 7) corresponding to the magnetic proximity switch 40 remains open. This prevents initiation of a cleaning cycle regardless of whether or not the door 16 of the warewasher 10 is closed.

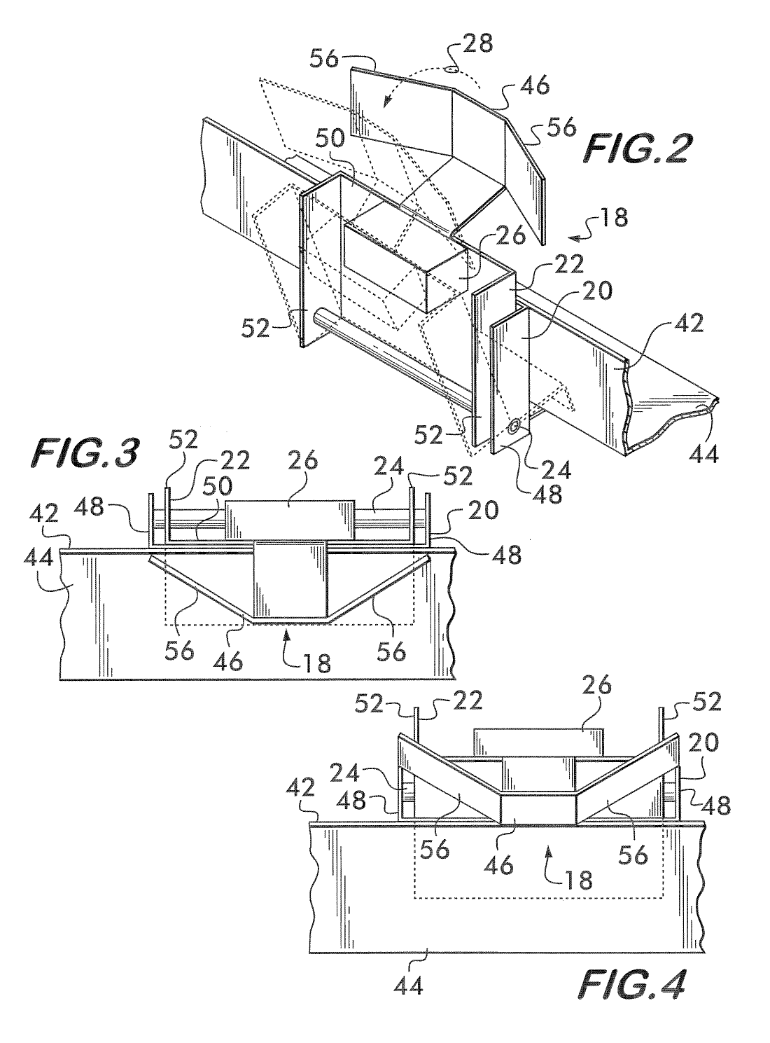

When a rack is inserted, rolled, or slid into the warewasher 10 on the tracks 44 and properly positioned within the warewasher for initiation of a new cleaning cycle, the rack engages the actuator 46 of the pivot arm 22 and causes the pivot arm 22 to pivot relative to the stationary anchor plate or mounting bracket 20 about the hinge pin 24. For instance, see the arrow 28 in FIG. 6 representing the force exerted by a rack (shown in phantom in FIG. 6) on the actuator 46 of the sensor assembly 18, and see the position of the pivot plate 22 relative to the position of the stationary anchor plate or mounting bracket 20 which is fastened to the upright 42 of a track 44 or the like of the warewasher 10. Also, see the dashed line representation of the pivot plate 22 in FIG. 2. By way of example, the pivot plate 22 can be designed to rotate about a longitudinal axis of the hinge pin 24 through a minimum of about 12.5° to a maximum of about 25°. This rotation is best illustrated in FIG. 6.

The magnet 26 is carried/mounted on the pivot plate 22 and will therefore be located in closer proximity to the magnetic proximity switch 40 when in the pivoted position illustrated in FIGS. 4 and 6. Accordingly, with this close spacing, the magnetic proximity switch 40 will sense the magnet 26 causing the electrical contact 34 of the magnetic proximity switch 40 to close enabling a cleaning cycle to begin provided, of course, that the door 16 of the warewasher 10 is closed.

FIG. 7 provides a simplified electrical circuit diagram of the components used to initiate the cleaning cycle of the door-type, stationary rack warewasher of the present invention. To this end, a door-mounted switch (not shown) is automatically depressed when the door 16 of the warewasher 10 is in the closed position. Activation of the door switch powers a relay 30 which causes a normally-open contact 32 to close in the above referenced circuit. The magnetic proximity switch 40, discussed above, has a contact 34 is wired in series with the relay 30 of the door-mounted switch. When the contacts 32 and 34 of both the door-mounted switch and the magnetic proximity switch 40 are closed, indicating that the door 16 is closed and a rack is properly loaded within the warewasher 10, a cleaning cycle is activated. Of course, if the door 16 is not closed or if a rack is not sensed within the warewasher, at least one of the contacts 32 and 34 will remain in a normally-open condition and a new cleaning cycle will not be initiated.

In the illustrated embodiments, the sensor assembly 18 is provided in a configuration that can be repeatedly engaged with a rack and pivoted between normal and pivoted positions without undue wear and tear. The mounting bracket 20 is generally U-shaped in transverse cross section and includes a set of opposed walls 48, and the pivot arm 22 includes a body section 50 having a generally U-shaped cross-section including a set of opposed walls 52. The body section 50 retracts into the U-shaped mounting bracket 20 when the pivot arm 22 is in the normal position. The pivot arm 22 also includes a forwardly projecting base wall 54 that extends underneath the track 44. The base wall 54 ensures that the pivot arm 22 is properly weighted to return to the normal position when only under the force of gravity and defines a maximum allowable amount of pivot of the pivot arm 22. This is because the base wall 54 will contact the underside of the track 44 and thereafter prevent further pivoting of the pivot arm 22 which provides a means for preventing the pivot arm from undesired contact with the walls 12 of the warewasher 10.

Further, the actuator 46 has a generally V-shaped configuration having opposite tapered walls 56. As best illustrated in FIG. 3, this enables on incoming rack to progressively pivot the pivot arm 22 outward as the rack advances within the chamber of the warewasher. This prevents damage to the actuator 46 and pivot arm 22 when a rack is repeatedly loaded and unloaded within the warewasher. The actuator includes a pair of tapered walls 56 so that a rack advancing in either direction on the track 44 will provide the same result.

While a preferred door-type, stationary rack warewasher has been described in detail, various modifications, alterations, and changes may be made without departing from the spirit and scope of the present invention.

I claim:

1. A sensor assembly for determining the presence or lack thereof of a removable dishware rack within a washing and/or rinsing chamber of a warewasher, comprising:
a mounting bracket mounted in a stationary position within the chamber of the warewasher at a location beyond a path of travel of the dishware rack within the chamber;
a pivot arm connected to said mounting bracket and moveable relative to said mounting bracket between a normal position and a deflected position in which said pivot arm is pivoted in an outward direction relative to the path of travel of the rack;
a magnet mounted on said pivot aim;
an actuator extending from said pivot arm within the path of travel of the dishware rack within the chamber when the pivot arm is in said normal position, and said pivot arm pivoting to said deflected position when the dishware rack is properly loaded within the chamber and engages said actuator causing said pivot arm to pivot to said deflected position in which said actuator is pushed outside the path of travel of the rack; and
a magnetic proximity switch mounted on the warewasher for sensing said magnet so that said magnetic proximity switch is able to determine if said pivot arm is in said normal position or said deflected position thereby enabling the sensor assembly to determine whether or not the removable rack is loaded within the warewasher.

2. A sensor assembly according to claim 1, wherein said magnetic proximity switch includes an electrical contact that opens when said pivot arm is in said normal position and said magnet is not sensed by said magnetic proximity switch and that closes when said pivot arm is in said deflected position and said magnet is sensed by said magnetic proximity switch.

3. A sensor assembly according to claim 1, further comprising a pivot pin connecting said pivot arm to said mounting bracket, said pivot pin having a longitudinal axis defining an axis of rotation of said pivot arm relative to said mounting bracket.

4. A sensor assembly according to claim 3, wherein said pivot arm rotates about said axis of rotation from said normal position to said deflected position through a minimum of about 12.5° to a maximum of about 25°.

5. A sensor assembly according to claim 1, wherein said pivot arm is weighted such that said pivot arm returns to said normal position when acted upon solely by the force of gravity.

6. A sensor assembly according to claim 5, wherein said pivot arm includes a body section and a base wall extending forward of the body section underneath the path of the rack, said base wall limiting said pivot arm from rotating relative to said mounting bracket beyond a predetermined amount of rotation.

7. A sensor assembly according to claim 6, wherein said actuator extends forward from said body section and has a pair of opposed tapered walls extending at an angle relative to the path of the rack enabling said actuator to engage the rack advancing in either direction on the path.

8. A sensor assembly according to claim 1, wherein said magnetic proximity switch is mounted externally on the warewasher outside of the chamber.

9. A warewasher, comprising:
a plurality of walls defining an enclosed wash chamber within the warewasher, at least one of said walls comprising a door capable of being opened for loading or unloading a removable dishware rack;
at least one track extending within said chamber for supporting the removable dishware rack in a stationary position within said chamber during a wash cycle and on which the removable dishware rack travels in a path of travel as the dishware rack is loaded into said chamber and is unloaded from said chamber; and
a rack sensor assembly including a mounting bracket mounted in a stationary position on an external side of said track within said chamber, a pivot arm connected to said mounting bracket and moveable relative to said mounting bracket between a normal position and a deflected position in which said pivot arm is pivoted in an outward direction relative to said track, a magnet mounted on said pivot arm, and an actuator extending from said pivot arm over said track and within the path of travel of the dishware rack within the chamber when said pivot arm is in said normal position, said pivot arm pivoting to said deflected position when the dishware rack is properly loaded within the chamber and the rack engages said actuator causing said pivot arm to pivot to said deflected position in which said actuator is pushed to a location outside the path of travel of the rack; and
a magnetic proximity switch mounted externally on the warewasher for sensing said magnet so that said magnetic proximity switch is able to determine if said pivot arm is in said normal position or said deflected position thereby enabling the sensor assembly to determine whether or not the removable rack is loaded within the warewasher.

10. A warewasher according to claim 9, wherein said magnetic proximity switch includes an electrical contact that opens when said pivot aim is in said normal position and that closes when said pivot arm is in said deflected position, wherein said at least one door has a corresponding electrical contact that opens when said door is opened and that closes when said door is closed, and wherein the wash cycle of the warewasher cannot be initiated until said electrical contacts of both said magnetic proximity switch and said door are closed.

11. A warewasher according to claim 10, wherein said sensor assembly further comprises a pivot pin connecting said pivot arm to said mounting bracket, said pivot pin having a longitudinal axis defining an axis of rotation of said pivot arm.

12. A warewasher according to claim 11, wherein said pivot arm rotates about said axis of rotation from said normal position to said deflected position through a minimum of about 12.5° to a maximum of about 25°.

13. A warewasher according to claim 12, wherein said pivot arm is weighted such that said pivot arm returns to said normal position when acted upon solely by the force of gravity.

14. A warewasher according to claim 13, wherein said pivot arm includes a body section and a base wall extending forward of the body section underneath said track, said base wall limiting said pivot arm from rotating relative to said mounting bracket beyond a predetermined amount of rotation when said base wall engages said track when said pivot arm is in said deflected position.

15. A warewasher according to claim 14, wherein said actuator extends forward from said body section and has a pair of opposed tapered walls extending at an angle relative to said track enabling said actuator to engage the rack advancing in either direction on the track.

16. A warewasher according to claim 9, wherein said warewasher is a door-type, stationary-rack warewasher.
